(19) United States
(12) Patent Application Publication
(10) Pub. No.: US 2016/0010657 A1
(43) Pub. Date: Jan. 14, 2016

(54) COMPRESSOR WHEEL, CENTRIFUGAL COMPRESSOR, MACHINING METHOD FOR COMPRESSOR WHEEL, AND MACHINING APPARATUS FOR COMPRESSOR WHEEL

(71) Applicant: IHI Corporation, Koto-ku (JP)

(72) Inventors: Taichi KIMURA, Tokyo (JP); Takashi FUJIWARA, Tokyo (JP)

(73) Assignee: IHI Corporation, Koto-ku (JP)

(21) Appl. No.: 14/865,012

(22) Filed: Sep. 25, 2015

Related U.S. Application Data
(63) Continuation of application No. PCT/JP2014/067024, filed on Jun. 26, 2014.

(30) Foreign Application Priority Data
Jul. 4, 2013 (JP) 2013-141001

(51) Int. Cl. F04D 29/28; B23P 15/02; F04D 29/053; F04D 17/10; F04D 29/42

(52) U.S. Cl. CPC F04D 29/284; F04D 17/10; F04D 29/4206; F04D 29/053; B23P 15/02

(57) ABSTRACT

A compressor wheel includes a hub fixed to one end of a shaft, and a plurality of blades arranged on an outer periphery of the hub. Each blade has a leading edge and a trailing edge, and includes a wing surface that is a curved surface drawn by a trajectory of movement of a linear bus line. The bus line has an intersection with the trailing edge on the trailing edge side, and inclines to a direction approaching an inside of a radial direction of the shaft, as going from one end side to the other end side in an axial direction of the shaft.

### CROSS REFERENCE TO RELATED APPLICATIONS

This application is a continuation application of

International Application No. PCT/JP2014/067024, filed on Jun. 26, 2014, which claims priority to Japanese Patent Application No. 2013-141001, filed on Jul. 4, 2013, the entire contents of which are incorporated by references herein.

### BACKGROUND

1. Field

The present disclosure relates to a compressor wheel in which a plurality of blades is arranged on an outer periphery of a hub, a centrifugal compressor, a machining method for the compressor wheel, and a machining apparatus for the compressor wheel.

2. Description of the Related Art

A conventional turbocharger has a bearing housing that rotatably holds a turbine shaft. A turbine wheel is provided at one end of the turbine shaft. A compressor wheel is provided at other end of the turbine shaft. The turbocharger is connected to an engine, and exhaust gas discharged from the engine flows into the turbocharger. When the turbine wheel rotates by the exhaust gas, the compressor wheel is rotated by the rotation of the turbine wheel, via the turbine shaft. Note that a centrifugal compressor that rotates a compressor wheel by rotational power of a motor, or the like has also been widespread.

As shown in Japanese Patent Laid-Open Publication No. 2007-50444, a compressor wheel includes a hub, and a plurality of blades arranged around the hub and provided integrally with the hub. The hub, the plurality of blades, and a shroud (housing) that houses the compressor wheel form a flow passage in which a fluid is compressed. In other words, these play roles as wall surfaces of the flow passage of the fluid. A curved surface shape of a wing surface of the blade is classified into a shape including a point group and a shape including a bus line. The curved surface shape including the point group is formed by cutting using a tip of a tool, such as an end mill. On the other hand, the shape including the bus line is formed by cutting using a side surface of the tool, with a rotational axis direction of the tool, such as the end mill being aligned to a direction of the bus line. Since broad cutting can be made at one time in the cutting using the side surface of the tool, a machining time can be relatively reduced.

### SUMMARY

Incidentally, in machining of a wheel (a so-called bus line wheel) having a curved surface whose wing surface includes a bus line, a direction of the bus line near a trailing edge becomes substantially parallel to a rotational axis direction of the wheel, when the wheel is designed so that machining data becomes a minimum. In this case, there is a possibility that a holding part of a tool interferes with a workpiece of the wheel before machining or during machining, depending on a path of the tool during the machining. The use of a long tool in an axial direction is considered in order to avoid such interference. However, when a distance from the holding part to a contact portion of the tool with the workpiece becomes long, vibration of the tool during machining, so-called chatter, may be generated.

In addition, when the tool used for machining of the wing surface from a leading edge to the trailing edge is separated from a trailing edge side of a blade, there is a possibility that a tip of the tool is caught in the workpiece of the wheel, so-called press machining is performed, and that unnecessary machining marks remain. In order to reliably avoid such chatter and press machining, measures such as suppressing low a moving speed of the tool during machining are taken. However, machinability and a machining time have been wasted due to such measures.

An object of the present disclosure is to provide a compressor wheel in which enhancement of machinability reduces a machining time, a centrifugal compressor, a machining method for the compressor wheel, and a machining apparatus for the compressor wheel.

A first aspect of the present disclosure is a compressor wheel that rotates integrally with a shaft, and compresses and sends out a fluid sucked from a suction port formed in a centrifugal compressor body outward in a radial direction of the shaft, the compressor wheel including: a hub fixed to one end of the shaft; and a plurality of blades arranged on an outer periphery of the hub, wherein each blade has a leading edge that is an end of an upstream side in a flow direction of the fluid, and a trailing edge that is an end of a downstream side in the flow direction of the fluid, and includes a wing surface that is a curved surface drawn by a trajectory of movement of a linear bus line, and wherein the bus line has an intersection with the trailing edge on the trailing edge side, and the bus line having the intersection with the trailing edge inclines in a direction approaching an inside in the radial direction of the shaft, as going from one end side toward other end side in an axial direction of the shaft.

An angle between the trailing edge located closer to the other end side in the axial direction of the shaft than the intersection and the bus line located closer to the other end side in the axial direction of the shaft than the intersection may be not less than 20 degrees.

A second aspect of the present disclosure is a centrifugal compressor comprising: a centrifugal compressor body; a shaft rotatably supported by the centrifugal compressor body; and a compressor wheel that has a hub fixed to one end of the shaft, and a plurality of blades arranged on an outer periphery of the hub, that rotates integrally with the shaft, and that compresses and sends out a fluid sucked from a suction port formed in the centrifugal compressor body outward in a radial direction of the shaft, wherein each blade has a leading edge that is an end of an upstream side in a flow direction of the fluid, and a trailing edge that is an end of a downstream side in the flow direction of the fluid, and includes a wing surface that is a curved surface drawn by a trajectory of movement of a linear bus line, and wherein the bus line has an intersection with the trailing edge on the trailing edge side, and the bus line having the intersection with the trailing edge inclines in a direction approaching an inside in the radial direction of the shaft, as going from one end side toward other end side in an axial direction of the shaft.

A third aspect of the present disclosure is a machining method for a compressor wheel that cuts out awing surface having a leading edge serving as an end of an upstream side in a flow direction of a fluid, and a trailing edge serving as an end of a downstream side in the flow direction of the fluid, among a plurality of blades arranged on an outer periphery of a hub in the compressor wheel of a centrifugal compressor, wherein a tool is arranged at an initial position where an axial direction of a rotational axis of the tool is parallel to a direction of the leading edge of the blade, and where a tip of the tool is directed to the hub side, and wherein an inclination angle is an acute angle when the inclination angle from the initial position in the axial direction of the tool is continuously increased toward a direction where the axial direction approaches the direction of the trailing edge, while cutting a workpiece of a gap portion of the plurality of blades by a side surface of the tool from the leading edge toward the trailing edge, and when the workpiece is cut to the trailing edge and the wing surface is cut out.

A fourth aspect of the present disclosure is a machining apparatus of a compressor wheel which cuts out from a workpiece a wing surface having a leading edge serving as an end on an upstream side in a flow direction of a fluid, and a trailing edge serving as an end on a downstream side in the flow direction of the fluid, among a plurality of blades arranged on an outer periphery of a hub in a compressor wheel of a centrifugal compressor, the machining apparatus including: a rotating section that supports a tool, and rotates the tool around an axial center of the tool; a moving section that displaces relative positions and attitudes of the tool and the workpiece; and a controller that controls rotation of the tool by the rotating section, and displacement of the relative positions and attitudes of the tool and the workpiece by the moving section, wherein the controller controls the moving section so that the tool is arranged at an initial position where an axial direction of a rotational axis of the tool is parallel to a direction of the leading edge, and where a tip of the tool is directed to the hub side, and controls the rotating section and the moving section so that an inclination angle becomes an acute angle, when the inclination angle from the initial position in the axial direction of the tool is continuously increased toward a direction where the axial direction of the tool approaches the direction of the trailing edge, while rotating the tool and cutting the workpiece of a gap portion of the plurality of blades by a side surface of the tool from the leading edge toward the trailing edge, and when the workpiece is cut to the trailing edge and the wing surface is cut out.

According to the present disclosure, it is possible to enhance machinability of the compressor wheel and to reduce a machining time.

### BRIEF DESCRIPTION OF THE DRAWINGS

FIG. 1 is a schematic cross-sectional view of a turbocharger according to one embodiment of the present disclosure.

FIG. 2 is a perspective view of a compressor wheel according to the one embodiment of the present disclosure.

FIG. 3A is a diagram for explaining a shape of a blade according to the one embodiment of the present disclosure, and FIG. 3B is a diagram for explaining a shape of a blade in a comparative example.

FIGS. 4A and 4B are diagrams for explaining a machining apparatus for the compressor wheel according to the one embodiment of the present disclosure.

FIGS. 5A to 5C are diagrams for explaining a machining method for the compressor wheel according to the one embodiment of the present disclosure and FIGS. 5D to 5F are diagrams for explaining a machining method for a wheel in the comparative example.

FIGS. 6A and 6B are diagrams for explaining machinability in machining of the blade.

FIGS. 7A to 7F are diagrams for explaining interference in machining of the blade.

### DESCRIPTION OF THE EMBODIMENTS

Hereinafter, a preferred embodiment of the present disclosure will be explained in detail with reference to accompanying drawings. Dimensions, materials, other specific numerical values, and the like shown in such an embodiment are merely exemplification for facilitating understanding of the invention, and they do not limit the present disclosure unless otherwise stated in advance. Note that, in the specification and the drawings, overlapping explanation of elements having substantially the same functions and configurations is omitted by attaching the same symbols to the elements, and that illustration of elements having no direct relation to the present disclosure is also omitted.

In the following embodiment, a compressor wheel of a turbocharger including components similar to a centrifugal compressor as one example of the centrifugal compressor, the turbocharger having the compressor wheel mounted thereon, a machining method for the compressor wheel, and a machining apparatus for the compressor wheel will be explained as examples.

First, a schematic configuration of the turbocharger having the compressor wheel mounted thereon will be explained, and then, a configuration of the compressor wheel, the machining method, and the machining apparatus for the compressor wheel will be explained in detail.

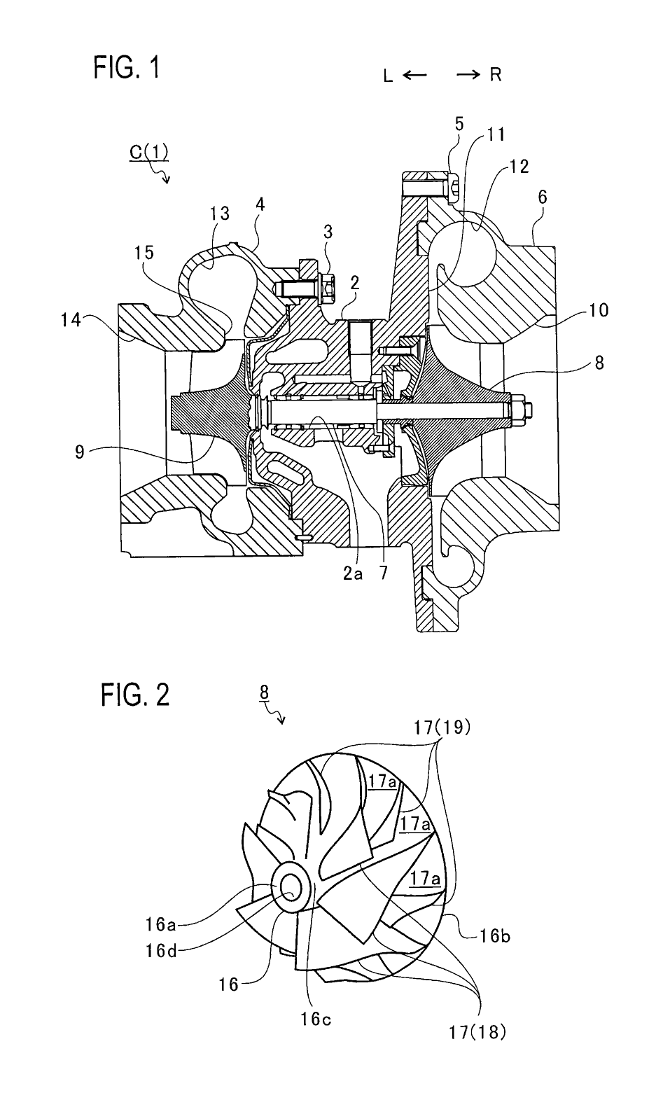

FIG. 1 is a schematic cross-sectional view of a turbocharger C. Hereinafter, explanation will be performed, with a direction of an arrow L shown in FIG. 1 being set as a left-hand side of the turbocharger C, and a direction of an arrow R being set as a right-hand side thereof. As shown in FIG. 1, the turbocharger C includes a turbocharger body 1 (a centrifugal compressor body). The turbocharger body 1 includes: a bearing housing 2; a turbine housing 4 coupled to a left-hand side of the bearing housing 2 by a fastening bolt 3; and a compressor housing 6 coupled to a right-hand side of the bearing housing 2 by a fastening bolt 5. These are integrated with each other.

A bearing hole 2a that penetrates in a horizontal direction of the turbocharger C is formed in the bearing housing 2. A turbine shaft 7 (a shaft) is rotatably supported in the bearing hole 2a, via a bearing. A compressor wheel 8 (a wheel) is integrally fixed to one end of the turbine shaft 7. The compressor wheel 8 is rotatably housed in the compressor housing 6. In addition, a turbine wheel 9 is integrally fixed to one end of the turbine shaft 7. The turbine wheel 9 is rotatably housed in the turbine housing 4.

A suction port 10 is formed in the compressor housing 6. The suction port 10 opens on a right-hand side of the turbocharger C. In addition, the suction port 10 is connected to an air cleaner (not shown). In addition, in a state where the bearing housing 2 and the compressor housing 6 are coupled to each other by the fastening bolt 5, facing surfaces of the both housings 2 and 6 form a diffuser flow passage 11 in which a pressure of a fluid is increased. The diffuser flow passage 11 is annularly formed from an inside toward an outer side in a radial direction of the turbine shaft 7 (compressor wheel 8). The diffuser flow passage 11 communicates with the suction port 10 formed in the compressor housing 6 via the compressor wheel 8, on the inside as described above.

A compressor scroll flow passage 12 is provided in the compressor housing 6. The compressor scroll flow passage 12 is located on the outside of the turbine shaft 7 (compressor wheel 8) in the radial direction than the diffuser flow passage 11. The compressor scroll flow passage 12 is annularly formed. The compressor scroll flow passage 12 communicates with an intake port (not shown) of an engine. In addition, the compressor scroll flow passage 12 also communicates with the diffuser flow passage 11. When the compressor wheel 8 rotates, the fluid is sucked in the compressor housing 6 from the suction port 10, and flows through an inter-wing of the compressor wheel 8. In this process, a velocity of the fluid increases by an action of a centrifugal force, and a pressure of the fluid is raised in the diffuser flow passage 11 and the compressor scroll flow passage 12, and the fluid whose pressure has been raised is guided to the intake port (not shown) of the engine. Namely, the compressor wheel 8 compresses and sends out the fluid sucked from a suction port 10 outward in the radial direction of the turbine shaft 7.

A turbine scroll flow passage 13 is formed in the turbine housing 4. The turbine scroll flow passage 13 is located on the outside of the turbine shaft 7 in the radial direction than the turbine wheel 9. The turbine scroll flow passage 13 is annularly formed. In addition, a discharge port 14 is formed in the turbine housing 4. The discharge port 14 communicates with the turbine scroll flow passage 13, via the turbine wheel 9. Furthermore, the discharge port 14 faces the front of the turbine wheel 9, and is connected to an exhaust gas purification apparatus (not shown).

In a state where the bearing housing 2 and the turbine housing 4 are coupled to each other by the fastening bolt 3, a gap 15 is formed between facing surfaces of these both housings 2 and 4. The gap 15 is annularly formed from the inside toward the outer side in the radial direction of the turbine shaft 7.

The turbine scroll flow passage 13 communicates with a gas inflow port (not shown) to which exhaust gas discharged from the engine is guided. In addition, the turbine scroll flow passage 13 communicates also with the above-described gap 15. The exhaust gas is guided from the gas inflow port to the turbine scroll flow passage 13, and is guided to the discharge port 14 via the turbine wheel 9. The exhaust gas rotates the turbine wheel 9 in this flow process. Additionally, a rotational force of the above-described turbine wheel 9 is transmitted to the compressor wheel 8 via the turbine shaft 7, the pressure of the fluid is raised by the rotational force of the compressor wheel 8, and the fluid whose pressure has been raised is guided to the intake port of the engine.

FIG. 2 is a perspective view of the compressor wheel 8. As shown in FIG. 2, the compressor wheel 8 has a hub 16 and a plurality of blades 17.

The hub 16 has a top surface 16a, and a bottom surface 16b with an area larger than the top surface 16a. The hub 16 further has an outer peripheral surface 16c that extends outward in the radial direction from the top surface 16a toward the bottom surface 16b. The hub 16 is a rotating body that rotates, with a center of the bottom surface 16b and the top surface 16a being set as a rotational axis.

In addition, a through-hole 16d is provided in the hub 16.

The turbine shaft 7 is inserted in the through-hole 16d that penetrates from the top surface 16a toward the bottom surface 16b. By this insertion, an end of the turbine shaft 7 projects from the top surface 16a. A thread groove is formed in the projecting portion. The hub 16 is fixed to one end of the turbine shaft 7 by fastening a nut to the thread groove.

The blade 17 is a thin plate-shaped member formed integrally with the hub 16. The plurality of blades 17 is arranged separated from each other in a peripheral direction, on the outer peripheral surface 16c of the hub 16. A gap (an inter-wing 17a) in a peripheral direction of the adjacent blades 17 serves as a flow passage of the fluid. In addition, the blade 17 extends outward in the radial direction from the outer peripheral surface 16c of the hub 16, and curves so as to incline in the peripheral direction of the hub 16.

Furthermore, the blade 17 includes a full blade 18 (a long blade), and a half blade 19 (a short blade, a half blade) whose length in an axial direction is shorter than the full blade 18. The full blade 18 and the half blade 19 are alternately arranged in the peripheral direction. As described above, the half blade 19 is arranged between the full blades 18, and thereby suction efficiency of the fluid in the turbocharger C is further enhanced compared with a case where the same number of blades 17 includes only the full blades 18. Hereinafter, when the blade is simply referred to as the blade 17, the blade indicates both the full blade 18 and the half blade 19.

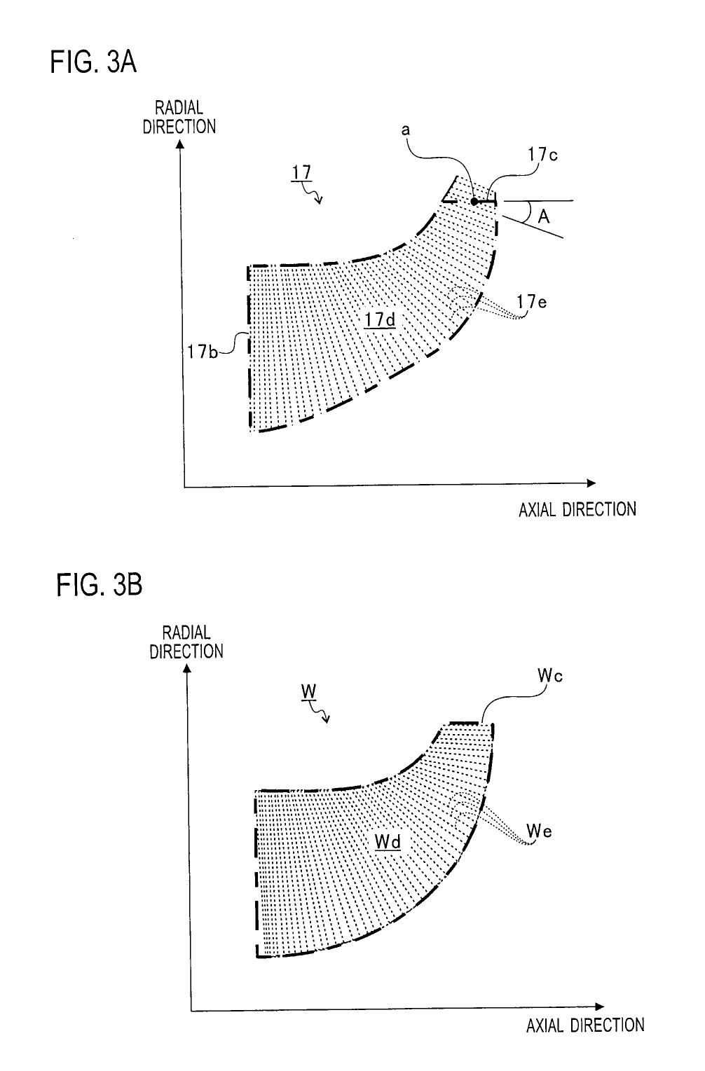

FIG. 3A is a diagram for explaining a shape of the blade 17. FIG. 3A shows a meridian surface shape of the blade 17 of the embodiment by an alternate long and short dash line. FIG. 3B shows a meridian surface shape of a blade W of a comparative example by an alternate long and short dash line. The meridian surface shape is the shape in which an outline of one blade 17 or W is rotated around a rotational axis of the hub 16 without changing a position of the hub 16 in the radial direction, and is projected on a flat surface parallel to the rotational axis of the hub 16. A horizontal direction indicates the axial direction of the turbine shaft 7 in FIGS. 3A and 3B. In addition, a right-hand side in each drawing indicates a bottom surface 16b side of the hub 16, and a left-hand side therein indicates a top surface 16a side of the hub 16. In addition, a vertical direction indicates the radial direction of the turbine shaft 7 in FIGS. 3A and 3B. An upper part in each drawing indicates the outside in the radial direction, and a lower part therein indicates the inside in the radial direction.

As shown in FIG. 3A, the blade 17 (i.e., the full blade 18 or the half blade 19) has a leading edge 17b that is an end of an upstream side in a flow direction of the fluid (hereinafter, simply referred to as the flow direction) that passes through the compressor wheel 8. Note that the leading edge 17b of the half blade 19 is located closer to a downstream side in the flow direction than the leading edge 17b of the full blade 18.

In addition, the blade 17 has a trailing edge 17c that is an end of the downstream side in the flow direction. A wing surface 17d is a curved surface of the blade 17, which has the leading edge 17b and the trailing edge 17c as ends of both sides in the flow direction. The wing surface 17d faces a flow passage formed in the inter-wing 17a.

As shown in FIG. 3A, in the meridian surface shape, the leading edge 17b is substantially parallel to the radial direction of the turbine shaft 7. The trailing edge 17c is substantially parallel to the axial direction of the turbine shaft 7.

The wing surface 17d is a curved surface drawn by a trajectory of continuous movement of a linear bus line 17e (it is shown by a broken line in FIG. 3A), with the leading edge 17b and the trailing edge 17c being set as the ends, i.e., a so-called ruled surface. Namely, the bus line 17e is a straight line in any position when a curved surface is drawn by movement of a straight line (a line segment). Accordingly, the compressor wheel 8 is configured as a so-called bus line wheel. In FIG. 3A, the bus line 17e is shown by being made to project from a trailing edge 17c side of the wing surface 17d, in order to facilitate understanding of a direction of the bus line 17e.

The bus line 17e has an intersection ‘a’ with the trailing edge 17c on the trailing edge 17c side. In addition, the bus line 17e inclines to a direction approaching the inside in the radial direction of the turbine shaft 7, as going from one end side (a left-hand side in FIG. 3A) to the other end side (a right-hand side in FIG. 3A) in the axial direction of the turbine shaft 7. Namely, in the bus line 17e that intersects with the trailing edge 17c, the one end side of the turbine shaft 7 in the axial direction is located on the outside in the radial direction than the other end side thereof.

Furthermore, when an angle between the trailing edge 17c located closer to the other end side (right-hand side in FIG. 3A) in the axial direction of the turbine shaft 7 than the intersection a and the bus line 17e located closer to the other end side (right-hand side in FIG. 3A) in the axial direction of the turbine shaft 7 than the intersection a is set to be an angle A, the angle A is not less than 20 degrees.

FIG. 3B shows the blade W of the comparative example. As shown in the drawing, a bus line We is specified by a curved surface shape of a wing surface Wd of the blade W. The bus line We is substantially parallel to the axial direction of the turbine shaft 7 on a trailing edge Wc side. Accordingly, unlike the blade 17 shown in FIG. 3A, the bus line We and the trailing edge Wc do not have an intersection. In this case, machining of the blade W may become difficult. Hereinafter, a machining apparatus for the compressor wheel 8 will be explained, and then, machinability of the blades 17 and W will be compared and explained in detail, while showing a machining method for the compressor wheel 8.

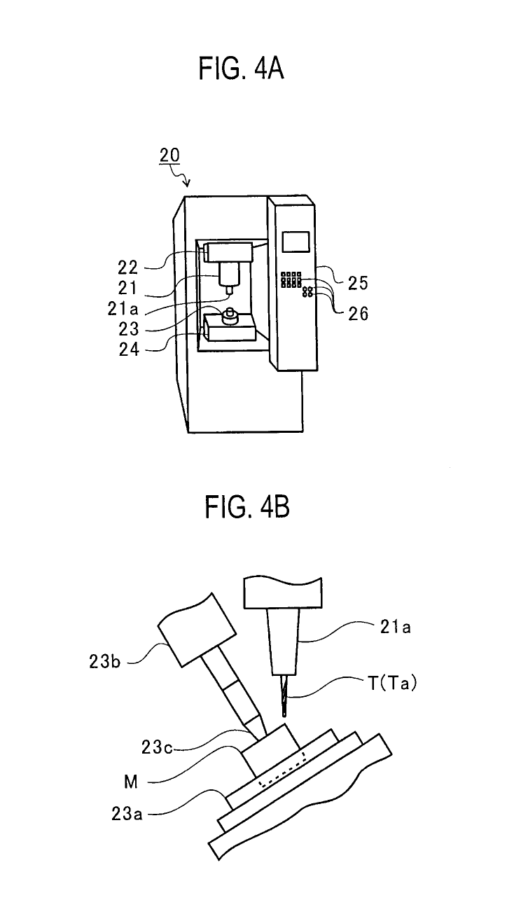

FIGS. 4A and 4B are diagrams for explaining a machining apparatus 20 of the compressor wheel 8. FIG. 4A shows an external view of the machining apparatus 20. FIG. 4B shows a condition of machining a workpiece M of the compressor wheel 8 by the machining apparatus 20.

The machining apparatus 20, for example, includes a simultaneous 5-axis machining center. As shown in FIG. 4A, the machining apparatus 20 includes: a rotating section 21; a moving section 22; a holding part 23; a moving section 24; a controller 25; and an operating part 26. As shown in FIG. 4B, the rotating section 21 has a chuck part 21a that supports a tool T such as an end mill, and a motor (not shown). The rotating section 21 rotates the tool T together with the chuck part 21a by power of the motor in a state where the chuck part 21a supports the tool T. The chuck part 21a supports the tool T in a state where a rotational axis of the chuck part 21a coincides with an axial center of the tool T.

The moving section 22 includes an automatic stage that can move three axes perpendicular to each other by, for example, the motor (not shown). The moving section 22 supports the rotating section 21. Additionally, the moving section 22 can move the rotating section 21 in any direction of three axes.

The holding part 23, for example, includes a clamping device. The holding part 23 holds the workpiece M of the compressor wheel 8. A hole that serves as the through-hole 16d of the hub 16 is previously formed in the workpiece M. The holding part 23 has a first clamp 23a that holds an outer peripheral surface of the workpiece M. Furthermore, a second clamp 23b is arranged on an opposite side of the first clamp 23a with the workpiece M in between. A pin 23c is fixed to the second clamp 23b. A tip of the pin 23c has a tapered shape with a smaller diameter toward a tip side. The tip of the pin 23c is inserted in the hole of the workpiece M serving as the through-hole 16d of the hub 16. In this way, the workpiece M is sandwiched by the first clamp 23a and the pin 23c.

The moving section 24 supports the holding part 23. The moving section 24 can pivot the workpiece M together with the holding part 23, around two axes different from each other by, for example, the motor (not shown).

Relative positions and attitudes of the tool T and the workpiece M can be displaced with a high degree of freedom by cooperation of the moving sections 22 and 24.

The controller 25 controls rotation of the tool T by the rotating section 21, and displacement of the relative positions and attitudes of the tool T and the workpiece M by the moving sections 22 and 24, in accordance with information such as a machining path that is input through the operating part 26. Hereinafter, a flow of machining processing of the compressor wheel 8 by the controller 25 will be explained in detail.

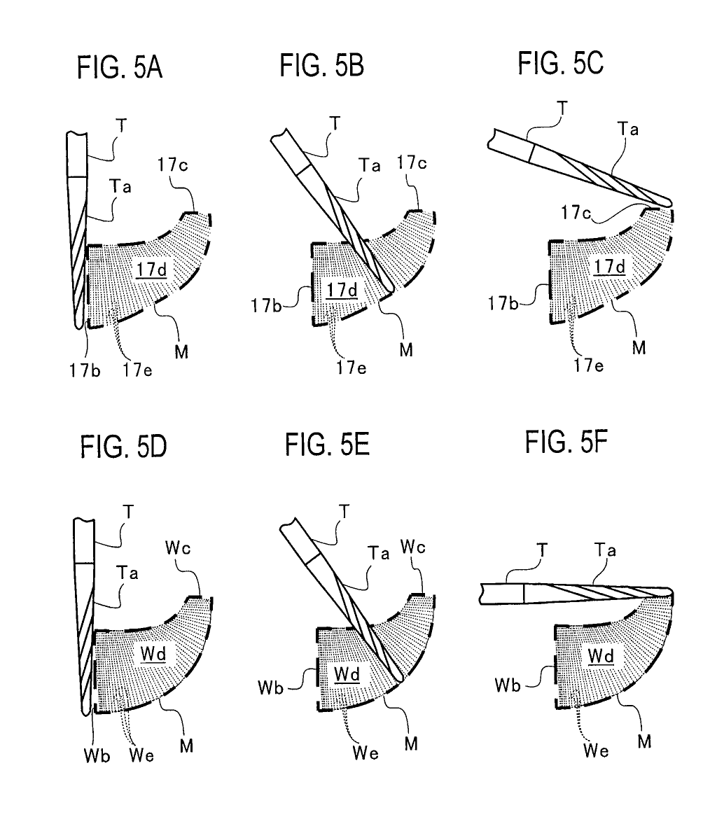

FIGS. 5A to 5F are diagrams for explaining the machining method for the compressor wheel 8. FIGS. 5A to 5C show machining processing of the blade 17 of the embodiment. FIGS. 5D to 5F show machining processing of the blade W of the comparative example. In order to facilitate understanding, illustration of the machining apparatus 20 in each drawing is omitted.

In machining of the bus line wheel, the workpiece M of the compressor wheel 8 is cut using an edge side surface Ta of the tool T. At this time, a rotational axis direction of the tool T is aligned to directions of the bus lines 17e and We.

As shown in FIG. 5A, the controller 25 controls the moving sections 22 and 24, and the rotating section 21, and arranges the tool T at an initial position where the axial direction of the rotational axis of the tool T is parallel to a direction of the leading edge 17b, and where a tip of the tool T is directed to a hub 16 side (a lower part in FIGS. 5A to 5F).

Subsequently, the controller 25 controls the moving sections 22 and 24, and the rotating section 21, and cuts the workpiece M by using the side surface Ta of the tool T, while aligning the rotational axis of the tool T to the direction (an extending direction) of the bus line 17e as shown in FIG. 5B. Namely, the controller 25 rotates the tool T, and cuts the workpiece M of a portion that serves as the gap (inter-wing 17a) between the plurality of blades 17, using the side surface Ta from the leading edge 17b toward the trailing edge 17c. During this cutting, the controller 25 continuously increases an inclination angle from the initial position in the axial direction of the tool T, in a direction where the axial direction of the tool T approaches the direction (extending direction) of the trailing edge 17c.

Additionally, as shown in FIG. 5C, when the tool T finishes machining to the trailing edge 17c side, the rotational axis of the tool T inclines to the axial direction of the turbine shaft 7. Specifically, the rotational axis of the tool T inclines so that a tip side of the tool T comes close to the inside of the turbine shaft 7 in the radial direction. Namely, when cutting the workpiece M to the trailing edge 17c and cutting out the wing surface 17d, the controller 25 controls the rotating section 21, and the moving sections 22 and 24 so that the inclination angle (an angle to which the axial direction of the tool T inclines, from FIGS. 5A to 5C) from the initial position in the axial direction of the tool T becomes an acute angle.

On the other hand, in machining of the blade W of the comparative example, in the same way as the machining of the blade 17, cutting is started from a leading edge Wb side in a state where the tip of the tool T is directed to the inside of the turbine shaft 7 in the radial direction (refer to FIG. 5D). In addition, as shown in FIG. 5E, cutting is performed from the leading edge Wb toward the trailing edge Wc, while the attitude of the tool T is controlled so that a direction of the bus line We becomes the direction of the rotational axis of the tool T. At the time of reaching the trailing edge Wc, the rotational axis of the tool T becomes substantially parallel to the axial direction of the turbine shaft 7, as shown in FIG. 5F.

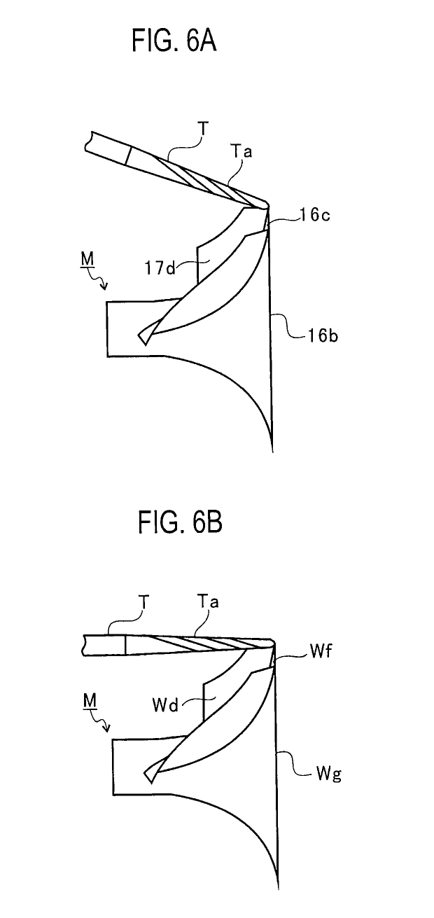

FIGS. 6A and 6B are diagrams for explaining machinability in machining of the blades 17 and W, respectively. FIG. 6A shows the blade 17 and the tool T in a state where the workpiece M is machined to the trailing edge 17c as in FIG. 5C. FIG. 6B shows the blade W and the tool T in a state where the workpiece M is machined to the trailing edge Wc as in FIG. 5F. These drawings show the blades 17 and W, with the number of blades 17 and W being decreased, in order to facilitate understanding.

When the tool T is separated in the radial direction of the turbine shaft 7 from the state shown in FIG. 6B, the tip of the tool T is caught in a portion of the workpiece M, the portion formed on a bottom surface Wg side in an outer peripheral surface Wf of the hub. Namely, the tool T performs unnecessary, so-called press machining. In this case, there is a possibility that unnecessary machining marks remain on the bottom surface Wg side of the outer peripheral surface Wf. Although it is considered that a moving speed of the tool T during machining is suppressed low in order to reliably avoid the press machining, machinability and a machining time are wasted.

In the machining of the blade 17 of the embodiment, the tool T is separated in the radial direction of the turbine shaft 7 from the trailing edge 17c side of the blade 17, in the state shown in FIG. 6A. In this case, the axial direction of the tool T inclines to a direction where the tip side of the tool T comes close to the inside of the turbine shaft 7 in the radial direction, with respect to the axial direction of the turbine shaft 7. Therefore, generation of press machining is suppressed, and enhancement of machinability and reduction in the machining time become possible.

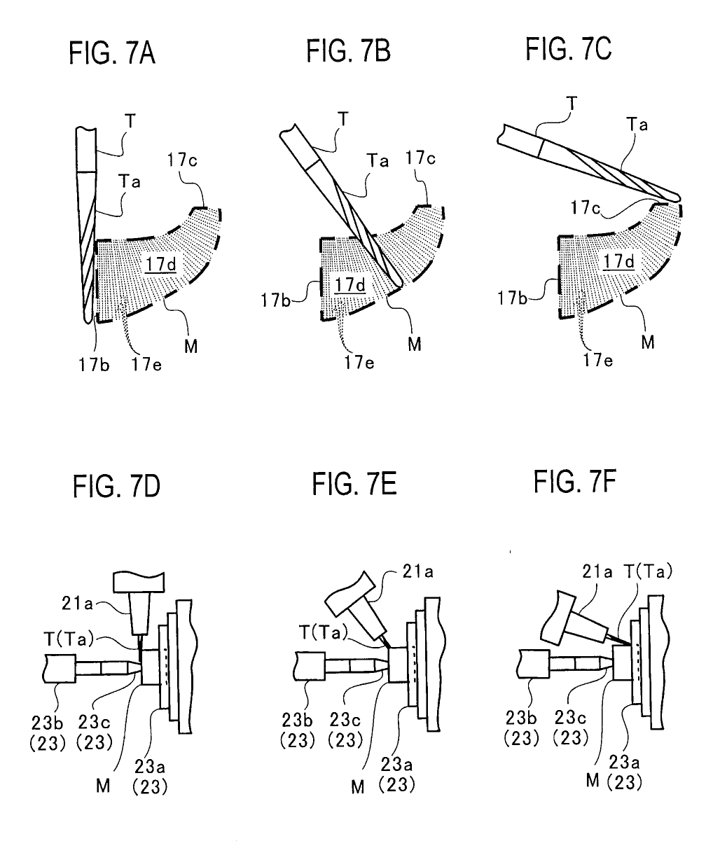

FIGS. 7A to 7F are diagrams for explaining interference in the machining of the blade 17. FIGS. 7A to 7C show the same drawings as FIGS. 5A to 5C. FIGS. 7D to 7F show relative attitudes of the chuck part 21a to the holding part 23 corresponding to FIGS. 7A to 7C, respectively. Note that FIGS. 7D to 7F show change in attitude of the chuck part 21a in order to facilitate understanding. Actually (for example, when the simultaneous 5-axis machining center is used), attitudes (inclinations) of the holding part 23 and the workpiece M held by the holding part 23 change.

As shown in FIGS. 7A to 7C, when the tool T reaches the trailing edge 17c from the leading edge 17b while cutting out the wing surface 17d, attitude control is performed in a direction where a distance between the chuck part 21a and the second clamp 23b is brought close as shown in FIGS. 7D and 7F.

For example, when the direction of the rotational axis of the tool T is moved until the direction becomes substantially parallel to the axial direction of the turbine shaft 7 as in the machining of the blade W of the comparative example, the distance between the chuck part 21a and the second clamp 23b becomes further shorter than a state shown in FIG. 7F. In this case, there is a possibility that the chuck part 21a and the second clamp 23b interfere with each other. It is considered that a long tool is used in a rotational axis direction in order to avoid such interference. Although the use of such a tool brings the tool close to the second clamp 23b instead of the chuck part 21a, the tool and the second clamp 23b do not easily interfere with each other since a diameter of the tool is smaller than that of the second clamp 23b. However, when a distance from the chuck part 21a to a contact portion of the tool with the workpiece M becomes long, vibration of the tool during machining, so-called chatter, may be generated.

In the machining of the blade 17 of the embodiment, since the direction of the tool T is not displaced only to an inclination shown in FIG. 7F, the chuck part 21a of the tool T becomes hard to interfere with the second clamp 23b. That is, the short tool T can be used. As a result, vibration of the tool caused during machining can be suppressed, and machinability can be enhanced.

In addition, the angle A in the above-mentioned embodiment is not less than 20 degrees. However, as long as effects of the present disclosure are obtained by an inclination of the bus line 17e with respect to the axial direction of the turbine shaft 7, a value of the angle A is arbitrary. However, when the angle A is set to be not less than 20 degrees as shown in FIG. 3A, a suppression effect is remarkably exerted on the above-described press machining, and the above-described interference between the chuck part 21a of the tool T and the holding part 23, and improvement in machinability and reduction in the machining time can be further achieved. In addition, the angle A is desirably not more than 40 degrees. A range of a curved surface shape that can be designed as the wing surface 17d of the blade 17 can be set to be a practical level by setting the angle A to be not more than 40 degrees.

Here, a flow of air that passes through the compressor wheel is assumed. Generally, change on an upstream side in the flow of the air tends to easily affect compressor efficiency. Meanwhile, the leading edge is located on the upstream side (upstream end) of the flow of the air, and the trailing edge is located on a downstream side (downstream end) thereof. An inclination of the bus line of the embodiment gradually changes from the leading edge toward the trailing edge. Namely, although the bus line of the embodiment is parallel to the leading edge as well as the comparative example (refer to FIG. 3B), the bus line inclines to the trailing edge. For this reason, change on the upstream side in the flow is suppressed, and influence on the compressor efficiency by the change of the flow can be reduced.

Note that, when the compressor efficiencies were compared using CFD (Computational Fluid Dynamics) analysis, in cases where the angle A was 0 degree (i.e., a case where the bus line in the trailing edge did not have an inclination), 20 degrees, and 40 degrees, it was found that the compressor efficiency of the case where the angle A was 20 or 40 degrees was substantially equal compared with the case where the angle A was 0 degree, and that a difference in the compressor efficiency was suppressed within the variation of less than 1%.

As described above, enhancement of machinability and reduction in a machining time can be achieved in the compressor wheel 8, the turbocharger C, the machining method for the compressor wheel 8, and the machining apparatus 20 of the compressor wheel 8, of the present embodiment.

Hereinbefore, although the preferred embodiment of the present disclosure has been explained with reference to the accompanying drawings, it is needless to say that the present disclosure is not limited to such an embodiment. It is apparent that those skilled in the art could have conceived of various modifications or correction examples in a category described in claims, and they are also naturally understood to belong to the technical scope of the present disclosure.

What is claimed is:

1. A compressor wheel that rotates integrally with a shaft, and compresses and sends out a fluid sucked from a suction port formed in a centrifugal compressor body outward in a radial direction of the shaft, the compressor wheel comprising:
a hub fixed to one end of the shaft; and
a plurality of blades arranged on an outer periphery of the hub,
wherein each blade has a leading edge that is an end of an upstream side in a flow direction of the fluid, and a trailing edge that is an end of a downstream side in the flow direction of the fluid, and includes a wing surface that is a curved surface drawn by a trajectory of movement of a linear bus line, and
wherein the bus line has an intersection with the trailing edge on the trailing edge side, and the bus line having the intersection with the trailing edge inclines in a direction approaching an inside in the radial direction of the shaft, as going from one end side toward other end side in an axial direction of the shaft.

2. The compressor wheel according to claim 1, wherein
an angle between the trailing edge located closer to the other end side in the axial direction of the shaft than the intersection and the bus line located closer to the other end side in the axial direction of the shaft than the intersection is not less than 20 degrees.

3. A centrifugal compressor comprising:
a centrifugal compressor body;
a shaft rotatably supported by the centrifugal compressor body; and
a compressor wheel including a hub fixed to one end of the shaft, and a plurality of blades arranged on an outer periphery of the hub, the compressor wheel configured to rotate integrally with the shaft, and configured to compress and send out a fluid sucked from a suction port formed in the centrifugal compressor body outward in a radial direction of the shaft,
wherein each blade has a leading edge that is an end of an upstream side in a flow direction of the fluid, and a trailing edge that is an end of a downstream side in the flow direction of the fluid, and includes a wing surface that is a curved surface drawn by a trajectory of movement of a linear bus line, and
wherein the bus line has an intersection with the trailing edge on the trailing edge side, and the bus line having the intersection with the trailing edge inclines in a direction approaching an inside in the radial direction of the shaft, as going from one end side toward other end side in an axial direction of the shaft.

4. A machining method for a compressor wheel that cuts out a wing surface having a leading edge that is an end of an upstream side in a flow direction of a fluid, and a trailing edge that is an end of a downstream side in the flow direction of the fluid, among a plurality of blades arranged on an outer periphery of a hub in the compressor wheel of a centrifugal compressor, wherein
a tool is arranged at an initial position where an axial direction of a rotational axis of the tool is parallel to a direction of the leading edge of the blade, and where a tip of the tool is directed to the hub side, and wherein
an inclination angle is an acute angle when the inclination angle from the initial position in the axial direction of the tool is continuously increased toward a direction where the axial direction approaches the direction of the trailing edge, while cutting a workpiece of a gap portion of the plurality of blades by a side surface of the tool from the leading edge toward the trailing edge, and when the workpiece is cut to the trailing edge and the wing surface is cut out.

5. A machining apparatus that cuts out from a workpiece a wing surface having a leading edge that is an end on an upstream side in a flow direction of a fluid, and a trailing edge that is an end on a downstream side in the flow direction of the fluid, among a plurality of blades arranged on an outer periphery of a hub in a compressor wheel of a centrifugal compressor, the machining apparatus comprising:
a rotating section configured to support a tool, and configured to rotate the tool around an axial center of the tool;
a moving section configured to displace relative positions and attitudes of the tool and the workpiece; and
a controller configured to:
control rotation of the tool by the rotating section, and displacement of the relative positions and attitudes of the tool and the workpiece by the moving section;
control the moving section so that the tool is arranged at an initial position where an axial direction of a rotational axis of the tool is parallel to a direction of the leading edge, and where a tip of the tool is directed to the hub side; and
control the rotating section and the moving section so that an inclination angle becomes an acute angle, when the inclination angle from the initial position in the axial direction of the tool is continuously increased toward a direction where the axial direction of the tool approaches the direction of the trailing edge, while rotating the tool and cutting the workpiece of a gap portion of the plurality of blades by a side surface of the tool from the leading edge toward the trailing edge, and when the workpiece is cut to the trailing edge and the wing surface is cut out.
